(19) United States
(12) Patent Application Publication
(10) Pub. No.: US 2025/0291635 A1
(43) Pub. Date: Sep. 18, 2025

(54) High Frequency Telemetry

(71) Applicant: MELLANOX TECHNOLOGIES, LTD., Yokneam (IL)

(72) Inventors: Amihay Tabul, Ness Ziona (IL); Alon Singer, Tel Aviv (IL); Ilya Vershkov, Rishon Lezion (IL); Zachy Haramaty, Ramat Gan (IL); Amir Hitron, Talmei Elazar (IL)

(21) Appl. No.: 18/607,830

(22) Filed: Mar. 18, 2024

(51) Int. Cl. G06F 9/50; G06F 9/48; H04Q 9/00

(52) U.S. Cl. CPC G06F 9/5027; G06F 9/4881; H04Q 9/00

(57) ABSTRACT

In one embodiment, a system includes a network device application-specific integrated circuit (ASIC), which includes a microcontroller to provide a command to a hardware accelerator to perform a job including gathering telemetry data from at least one hardware unit and write the gathered telemetry data to a memory, and the hardware accelerator to gather the telemetry data from the at least one hardware unit and write the gathered telemetry data to the memory based on the command.

### FIELD OF THE DISCLOSURE

The present disclosure relates to computer systems, and in particular, but not exclusively to, telemetry.

### BACKGROUND

In today's datacenter (DC), the relationship between high-frequency telemetry and Machine Learning (ML)/Artificial Intelligence (AI) workloads is crucial. Supporting high-frequency telemetry in network switches is key for gaining deep insights into network performance. This is especially significant with ML/AI workloads, where real-time responsiveness is critical. High-frequency telemetry will allow for detailed visibility into network dynamics, identifying bottlenecks and potentially also anomalies.

ML/AI workloads are known for their bursty nature and are bandwidth (BW) intensive. High-frequency telemetry plays an important role in detecting microbursts (e.g., an intense load for a very short period of time such as seconds or even milliseconds), drops, and congestion points in a way that traditional telemetry rates are not capable of detecting. This capability will enable DC operators to fine-tune networks, ensure optimal conditions, and debug high BW networks with traffic shaping that is rapidly changing with new ML/AI algorithms. High-frequency telemetry in network switches is not just a technological advancement; it is a strategic necessity with the current ML/AI workloads and with new algorithms that will emerge.

Additionally, bandwidth is also increasing from generation to generation, so if the current telemetry solutions are applied to higher bandwidths, the sampling will be too slow as the network may be changing between samples. For example, the network may look as though it is providing the desired performance, when in fact, high intensity bursts and drops may be missed.

### SUMMARY

There is provided in accordance with an embodiment of the present disclosure, a system, including a network device application-specific integrated circuit (ASIC), which includes a microcontroller to provide a command to a hardware accelerator to perform a job including gathering telemetry data from at least one hardware unit and write the gathered telemetry data to a memory, and the hardware accelerator to gather the telemetry data from the at least one hardware unit and write the gathered telemetry data to the memory based on the command.

Further in accordance with an embodiment of the present disclosure the network device ASIC includes the at least one hardware unit.

Still further in accordance with an embodiment of the present disclosure the at least one hardware unit includes ports, buffers, and packet processing circuitry.

Additionally in accordance with an embodiment of the present disclosure the microcontroller is to execute firmware to provide the command to the hardware accelerator to perform the job including gathering the telemetry data from the at least one hardware unit and write the gathered telemetry data to the memory.

Moreover, in accordance with an embodiment of the present disclosure the hardware accelerator is to gather the telemetry data from the at least one hardware unit and write the gathered data to a host memory of a host device connected to the network device via a data communication bus.

Further in accordance with an embodiment of the present disclosure the microcontroller is to receive a request from software executed by a central processing unit (CPU) of the host device to gather the telemetry data, and in response to receiving the request provide the command to the hardware accelerator to perform the job.

Still further in accordance with an embodiment of the present disclosure the hardware accelerator is to provide an indication to the microcontroller when the hardware accelerator completes the job gathering the telemetry data, and the microcontroller is to provide a notification to the software executed by the CPU that the job has been completed.

Additionally in accordance with an embodiment of the present disclosure, the system includes a host device including a host memory, and a CPU to execute software to provide a request to the microcontroller to gather the telemetry data and write the gathered telemetry data to the host memory, wherein the microcontroller is to, in response to receiving the request, provide the command to the hardware accelerator to perform the job, and the hardware accelerator is to gather the telemetry data from the at least one hardware unit and write the gathered telemetry data to the host memory.

Moreover, in accordance with an embodiment of the present disclosure the hardware accelerator is to provide an indication to the microcontroller when the hardware accelerator completes the job gathering the telemetry data, and the microcontroller is to provide a notification to the software executed by the CPU that the job has been completed.

Further in accordance with an embodiment of the present disclosure network device is a network switch, and the hardware units include switching circuitry.

Still further in accordance with an embodiment of the present disclosure the hardware accelerator includes a direct memory access (DMA) hardware accelerator.

Additionally in accordance with an embodiment of the present disclosure the hardware accelerator is to sample the telemetry data from the at least one hardware unit at a rate faster than every millisecond.

Moreover, in accordance with an embodiment of the present disclosure the hardware accelerator is to sample the telemetry data from the at least one hardware unit so that each sample includes a timestamp and values gathered from the at least one hardware unit.

Further in accordance with an embodiment of the present disclosure the gathered telemetry data includes any one or more of the following counter values maintained by the at least one hardware unit, values from histograms, and temperature values.

Still further in accordance with an embodiment of the present disclosure the counter values provide an indication of any one or more of the following a number of packets transmitted and/or received, a number of bytes transmitted and/or received, buffer occupancy for a given one of the ports for a given one of the buffers or a priority on the given port, and a number of pause frames transmitted and/or received, and a number of inbound packets chosen to be discarded.

Additionally in accordance with an embodiment of the present disclosure the hardware accelerator is to provide an indication to the microcontroller when the hardware accelerator completes the job gathering the telemetry data, and the microcontroller is to provide a notification to software executed by a CPU of a host device that the job has been completed.

Moreover, in accordance with an embodiment of the present disclosure the command for the job indicates the at least one hardware unit and timing data including any one or more of the following a duration of the job, a number of samples to be taken, a sampling frequency, or a time gap between each of the samples.

Further in accordance with an embodiment of the present disclosure the command for the job indicates the at least one hardware unit and timing data including any one or more of the following a sampling frequency, or a time gap between each of the samples.

Still further in accordance with an embodiment of the present disclosure the job has a fixed duration defined by the timing data including a duration of the job or a number of samples to be taken.

Additionally in accordance with an embodiment of the present disclosure the command for the job indicates that the telemetry data is to be written to a ring buffer in the memory.

Moreover, in accordance with an embodiment of the present disclosure the microcontroller is to receive a request from software executed by a CPU of a host device that the job should be terminated, and provide a command to the hardware accelerator to terminate the job.

Further in accordance with an embodiment of the present disclosure the hardware accelerator is to clear the telemetry data from the at least one hardware unit upon gathering the telemetry data.

There is also provided in accordance with another embodiment of the present disclosure, a method, including providing a command by a microcontroller to a hardware accelerator to perform a job including gathering telemetry data from at least one hardware unit and write the gathered telemetry data to a memory, and gathering by the hardware accelerator the telemetry data from the at least one hardware unit and write the gathered telemetry data to the memory based on the command.

### BRIEF DESCRIPTION OF THE DRAWINGS

The present disclosure will be understood from the following detailed description, taken in conjunction with the drawings in which:

FIG. 1 is a block diagram view of a telemetry system constructed and operative in accordance with an embodiment of the present disclosure;

FIG. 2 is a flowchart including steps in a method performed by software running on a host device in the system of FIG. 1;

FIG. 3 is a flowchart including steps in a method performed by a microcontroller in the system of FIG. 1;

FIG. 4 is a schematic view of a command provided by the microcontroller in the system of FIG. 1;

FIG. 5 is a flowchart including steps in a method performed by a hardware accelerator in the system of FIG. 1; and

FIG. 6 is a schematic view of a telemetry data sample generated in the system of FIG. 1.

### DESCRIPTION OF EXAMPLE EMBODIMENTS

### Overview

As previously mentioned, high frequency telemetry is very important, and in particular, but not exclusively, for intense and bursty workloads such as ML/AI workloads. High frequency telemetry is also more challenging as bandwidth requirements are increasing. In certain hardware scenarios, such as network switches, where the network device application-specific Integrated Circuit (ASIC) may have a high number of ports (e.g., 256 ports) and other hardware units to sample, the challenge of high frequency telemetry is even greater. For example, port metadata maintained by counters (e.g., 64 bits per counter) counting the number of packets and bytes transmitted and received may be sampled for different ports, and buffer occupancy may be sampled for a specific port for a specific buffer or priority in that port. If buffer occupancy is sampled at a very high rate, the sampling will provide a view of how buffer size changes over time and an analyzer or analysis tool may be able to correlate the changes to something occurring in the network. If buffer occupancy is sampled at a lower rate, the buffer may simply look empty, and analysis will not be able to correlate the buffer occupancy with something occurring in the network.

Collecting large amounts of ASIC-sourced telemetry data using a software-based solution is central processing unit (CPU) intensive and may prevent the CPU from performing other critical work on a timely basis, and therefore, high speed telemetry which relies on a CPU intensive process is unlikely to be a solution in a production environment.

One solution is for microcontrollers in the ASIC to collect the telemetry data, with one microcontroller for each counter, and for the CPU running on a host device to process the sampled data in bulk each time the counters are sampled by each microcontroller. The above solution still requires: a high level of CPU involvement, which may overload the CPU of the host device and firmware of the network device; many microcontrollers to perform the telemetry job; and enough memory on the ASIC for the microcontrollers to write the samples to, and ASICs typically do not have enough memory. In addition, the above solution would probably only provide a sampling time in the order of 10s or 100s of milliseconds, which is too slow for many applications which may require a sampling time in the sub-millisecond range.

Therefore, embodiments of the present disclosure, address at least some of the above drawbacks by providing high speed telemetry in a network device such as a network switch using a hardware accelerator (e.g., a direct memory access (DMA) hardware accelerator) of the network device ASIC to gather telemetry data from hardware units (e.g., from counters maintained by the hardware units at ports, switching circuitry, buffers, and/or management system) in the network device ASIC and write the gathered telemetry data to a memory, e.g., to a host memory of a host device.

In some embodiments, the CPU of the host device allocates a section of memory in the host memory for the hardware accelerator to write the telemetry data thereto. When an administrator or user issues a request to collect telemetry data, the software running on the CPU of the host device generates a request for a job and provides the request for the job to the microcontroller (e.g., to the firmware running on the microcontroller) on the network device ASIC to collect the telemetry data. The microcontroller generates a command and provides the command to the hardware accelerator to gather telemetry data from one or more given hardware units (e.g., ports, buffers, or packet processing circuitry) and write the gathered telemetry data to the allocated host memory. In some cases, the telemetry data may be read by the CPU once the job is completed. In some cases, the telemetry data may be read while the job is still being performed. For example, the command may specify that the telemetry data should be written to a ring buffer which is overridden by the hardware accelerator in a cyclic fashion, and the CPU reads the data from the ring buffer while the job is still being performed.

Once the hardware accelerator completes the job, the hardware accelerator provides a notification to the microcontroller (e.g., via an interrupt or polling or by updating a bit or flag in memory), which provides a notification to the software running on the CPU that the job has been completed.

The command may include a job duration, or a number of samples to be taken, or the job may be open ended and may continue until the CPU informs the microcontroller, which informs the hardware accelerator that the job should be terminated. The command may include a sampling frequency, or a time gap between samples, to enable the hardware accelerator to manage the timing of the samples. In other embodiments, the microcontroller may manage the timing of the samples and provide an indication to the hardware accelerator each time a sample should be taken. The hardware accelerator may be able to sample telemetry data from the hardware units at a rate faster than every millisecond.

The gathered telemetry data may include any suitable data, for example, any one or more of the following: counter values maintained by the hardware unit(s), values from histograms, and temperature values. The counter values may provide an indication of any one or more of the following: the number of packets transmitted and/or received, the number of bytes transmitted and/or received, buffer occupancy for a given port for a given buffer or a priority on the given port, and a number of pause frames transmitted and/or received, and a number of inbound packets chosen to be discarded.

When the host device and the ASIC microcontroller are not involved in gathering the telemetry data, the administrator or user may make many more requests for telemetry data gathering and at a faster sampling rate. In some embodiments, the host device is not involved in each sampling iteration and only collects the data intermittently, and typically only after the job has terminated.

In some embodiments, the hardware accelerator may add a timestamp (e.g., in UTC format) to the sampled data, which is taken from one or more hardware units, for example, to support the option to export the telemetry data collected to a time series database (for example InfluxDB®—www.influxdata.com). This may enable the user to find the point in time that the telemetry data was collected and synchronize the telemetry data with other metrics collected from other network devices (assuming that the time has been synchronized among the network device).

Embodiments of the present disclosure improve the way a computer or other processing device works by providing better computer performance, providing higher processing speed, providing less latency, reduced power consumption, and/or increasing data access speed.

### System Description

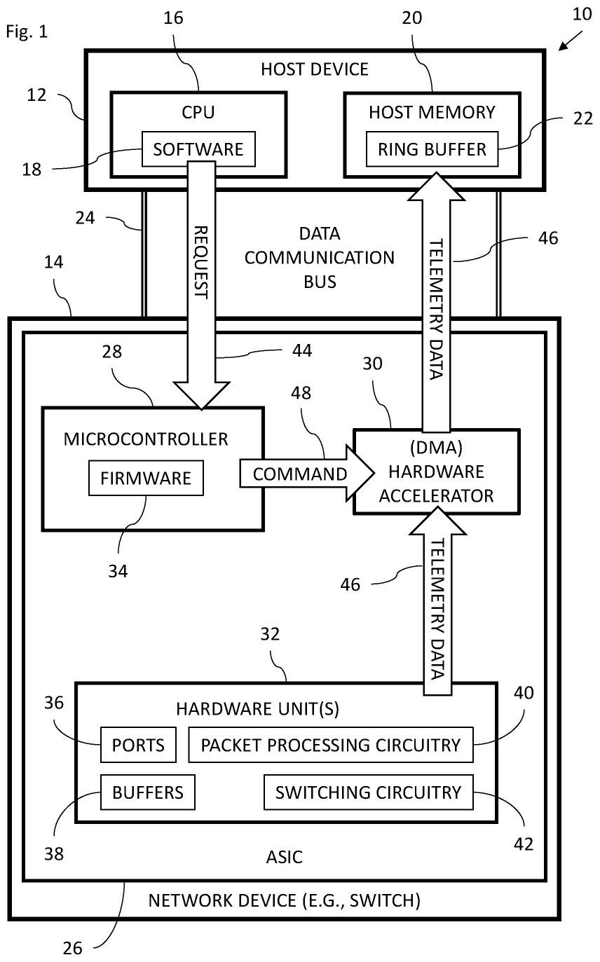

Reference is now made to FIG. 1, which is a block diagram view of a telemetry system 10 constructed and operative in accordance with an embodiment of the present disclosure. The telemetry system 10 includes a host device 12 and a network device 14, such as a network switch.

The host device 12 includes a central processing unit (CPU) 16 to execute software 18, and a host memory 20. In some embodiments, the host memory 20 may include an allocated ring buffer 22. The host device 12 may be connected to the network device 14 via any suitable interface, for example, a data communication bus 24, which is operative according to any suitable interface protocol, such as Peripheral Component Interconnect Express (PCIe).

The network device 14 includes a network device application-specific integrated circuit (ASIC) 26. The network device ASIC 26 includes a microcontroller 28 (and typically more than one microcontroller 28), a hardware accelerator 30, and hardware units 32.

In some embodiments, the microcontroller 28 is configured to execute firmware 34. In practice, some, or all of the functions of the microcontroller 28 may be combined in a single physical component or, alternatively, implemented using multiple physical components. These physical components may comprise hard-wired or programmable devices, or a combination of the two. In some embodiments, at least some of the functions of the microcontroller 28 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The hardware accelerator 30 may be any suitable hardware accelerator, which performs the functions described herein as a hard-wired device without running software or firmware within the hardware accelerator. In some embodiments, the hardware accelerator 30 includes a direct memory access (DMA) hardware accelerator. The hardware units 32 may include any suitable hardware units, such as ports 36, buffers 38, packet processing circuitry 40, and switching circuitry 42.

The software 18 running on the CPU 16 is configured to generate a request 44 and provide the request 44 to the microcontroller 28 to gather telemetry data 46 from one or more of the hardware units 32 according to various criteria described in more detail with reference to FIG. 4. The firmware 34 running on the microcontroller 28 is configured to receive the request 44 and generate a command 48 and provide the command 48 to the hardware accelerator 30 to gather the telemetry data 46 according to the request 44. The hardware accelerator 30 is configured to gather the telemetry data 46 from the hardware unit(s) 32 indicated in the command 48 according to the criteria included in the command 48 and write the telemetry data 46 to the host memory 20 over the data communication bus 24.

In some embodiments, the host device 12 may be remote to the network device 14 and may be connected to the network device 14 via a network (not shown). The hardware accelerator 30 may be configured to write the data to the host memory 20 over the network using any suitable protocol such as remote direct memory access (RDMA). In some embodiments, the hardware accelerator 30 may be configured to write the data to a local memory (not shown) in the network device 14, and optionally on the network device ASIC 26, and the written data is intermittently forwarded to the host device 12 (e.g., to the host memory 20) e.g., in packets, by the network device ASIC 26.

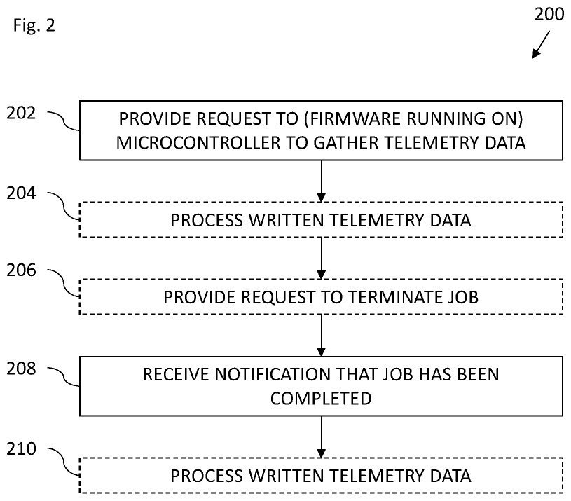

Reference is now made to FIG. 2, which is a flowchart 200 including steps in a method performed by software 18 running on host device 12 in the system 10 of FIG. 1. Reference is also made to FIG. 1. The software 18 is configured to receive a request from a user to initiate a job to collect telemetry data 46. The software 18 is configured to generate request 44 and provide request 44 to the firmware 34 running on the microcontroller 28 to gather telemetry data according to given criteria described in more detail with reference to FIG. 4 and to write the gathered telemetry data 46 to the host memory 20 (or any suitable memory) (block 202). In some embodiments, while the job is being performed by the hardware accelerator 30, the software 18 running on the CPU 16 is configured to process the telemetry data 46 written to the host memory 20 (block 204).

In some embodiments, the software 18 may not indicate the length of the job to the firmware 34 (for example, via a job duration, or end time, or a number of samples to be taken). The software 18 may be configured to provide a request to the firmware 34 to terminate the job based on some criterion or criteria (block 206).

Once the job has been completed by the hardware accelerator 30, the software 18 is configured to receive a notification from the firmware 34 that the job has been completed (block 208). The software 18 is configured to process the telemetry data 46 written to the host memory 20 (block 210).

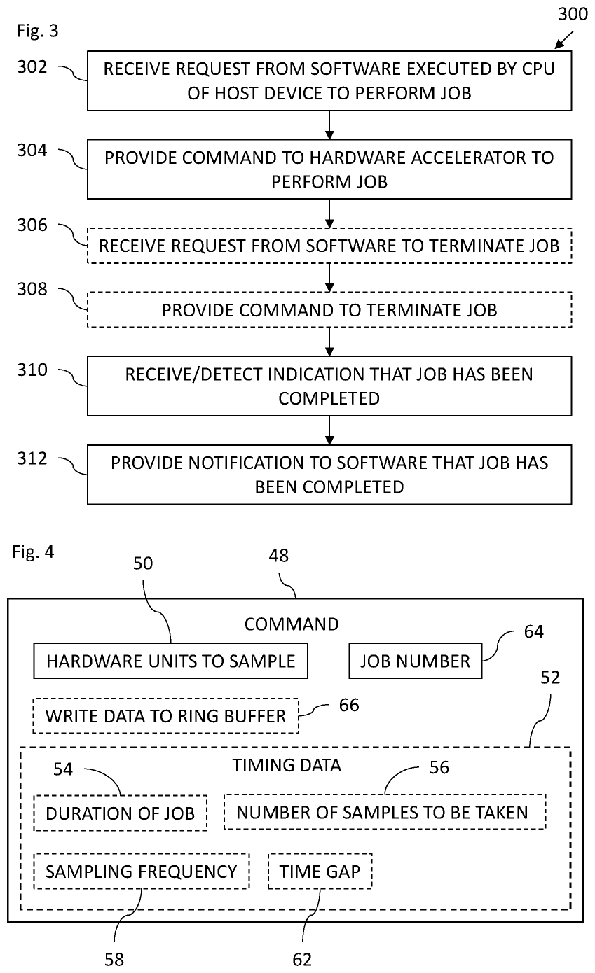

Reference is now made to FIG. 3, which is a flowchart 300 including steps in a method performed by microcontroller 28 in the system 10 of FIG. 1. Reference is also made to FIG. 1. The firmware 34 running on the microcontroller 28 is configured to receive request 44 from software 18 executed by CPU 16 of the host device 12 to perform the job for gathering telemetry data 46 (block 302).

Reference is now made to FIG. 4, which is a schematic view of command 48 provided by the microcontroller 28 in the system 10 of FIG. 1. Reference is also made to FIGS. 1 and 3. In response to receiving the request 44, the firmware 34 running on the microcontroller 28 is configured to generate command 48, provide command 48 to the hardware accelerator 30 to perform the job (block 304) including gathering telemetry data 46 from one or more of the hardware units 32, and write the gathered telemetry data 46 to the host memory 20.

The command 48 for the job may indicate (block 50) the hardware unit(s) 32 from which to gather the telemetry data 46 and optionally timing data 52 including any one or more of the following: a duration of the job 54 or a number of samples to be taken 56; a sampling frequency 58 or a time gap 62 between each of the samples. The command 48 may also include a job number 64 and indicate whether the telemetry data 46 is to be written to ring buffer 22 in the host memory 20 (block 66). In some cases, the job may be open ended (and may continue until the software 18 informs the firmware 34 running on the microcontroller, which informs the hardware accelerator that the job should be terminated) and therefore the timing data 52 does not include an indication of duration of the job or number of samples to be taken.

Reference is again made to FIG. 3. Reference is also made to FIG. 1. In some embodiments, for example, when the job has no fixed duration, or end time, or fixed number of samples to be taken, the firmware 34 running on the microcontroller 28 is configured to receive a request from the software 18 that the job should be terminated (block 306) and provide a command to the hardware accelerator 30 to terminate the job (block 308).

The firmware 34 running on the microcontroller 28 is configured to receive an indication from the hardware accelerator 30 (e.g., an interrupt) or detect (e.g., by polling the hardware accelerator 30 or by the hardware accelerator 30 writing a completion bit to a memory location for detection by the firmware 34) that the job has been completed (block 310). The firmware 34 running on the microcontroller 28 is configured to provide a notification to the software 18 executed by the CPU 16 of the host device 12 that the job has been completed (block 312). Any of the functionality described above with respect to the firmware 34 may be performed at least partially by software and/or hardware.

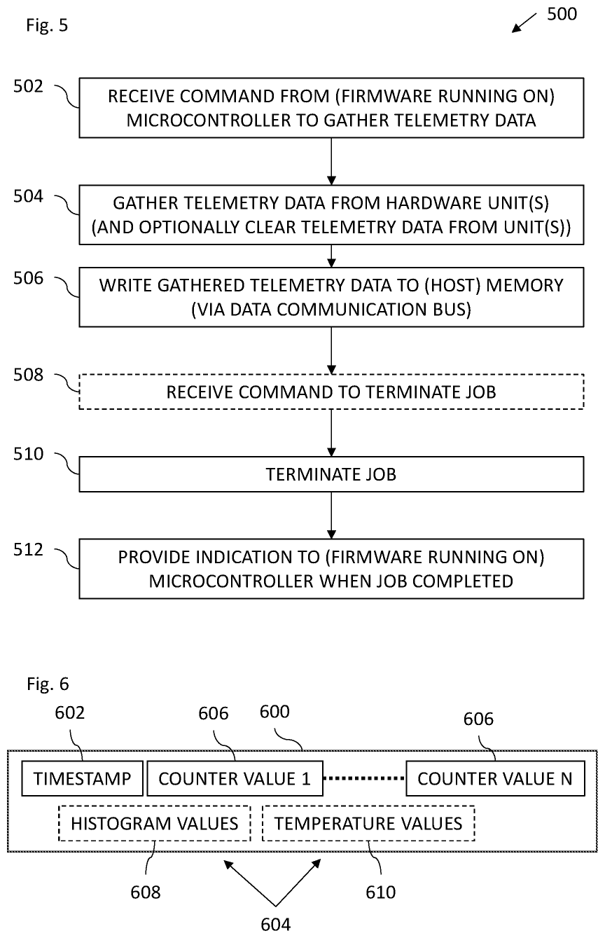

Reference is now made to FIG. 5, which is a flowchart 500 including steps in a method performed by the hardware accelerator 30 in the system 10 of FIG. 1. Reference also made to FIG. 1. The hardware accelerator 30 is configured to receive command 48 from the firmware 34 running on the microcontroller 28 to gather the telemetry data 46 (block 502).

Reference is now made to FIG. 6, which is a schematic view of a telemetry data sample 600 generated in the system 10 of FIG. 1. Reference is also made to FIGS. 1 and 5. The hardware accelerator 30 is configured to gather the telemetry data 46 from hardware unit(s) 32 (block 504) and optionally clear the telemetry data 46 from the hardware unit(s) 32 (e.g., clear the counters) upon gathering the telemetry data 46, and write the gathered telemetry data 46 to memory based on the command 48 (block 506). In some embodiments, the hardware accelerator 30 is configured to write the gathered telemetry data 46 to host memory 20 of the host device 12 connected to the network device 14 via data communication bus 24.

In some embodiments, the hardware accelerator 30 is configured to sample the telemetry data 46 from the hardware unit(s) 32 at a rate faster than every millisecond. In some embodiments, the hardware accelerator 30 is configured to time the sampling of the telemetry data 46 according to the sampling frequency 58 or time gap 62 included in the command 48 by comparing the next scheduled sampling time with a clock time maintained by the network device 14 or the hardware accelerator 30, by way of example. In other embodiments, the firmware 34 is configured to time the sampling of the telemetry data 46 according to the sampling frequency 58 or time gap 62 by comparing the next scheduled sampling time with a clock time maintained by the network device 14, by way of example, and providing an indication to the hardware accelerator 30 to perform the next sampling of the telemetry data 46 when the next scheduled sampling time occurs, or shortly before the next scheduled sampling time.

In some embodiments, the hardware accelerator 30 is configured to sample the telemetry data 46 from the hardware unit(s) 32 so that each sample 600 includes a timestamp 602 and values 604 gathered from the hardware unit(s) 32 at the time indicated by timestamp 602. The gathered telemetry data 46 (included in the telemetry data sample 600) may include any one or more of the following: counter values 606 maintained by the hardware unit(s) 32; values from histograms 608; and temperature values 610. The counter values may provide an indication of any one or more of the following: a number of packets transmitted and/or received; a number of bytes transmitted and/or received; buffer occupancy for a given port 36 for a given buffer 38 or a priority on the given port 36; and a number of pause frames transmitted and/or received; and a number of inbound packets chosen to be discarded. An overwhelmed network node can send a pause frame, which halts the transmission of the sender for a specified period of time.

Reference is again made to FIG. 5. Reference also made to FIG. 1.

In some embodiments, the hardware accelerator 30 is configured to receive a command from the firmware 34 running on the microcontroller 28 to terminate the job (block 508). The hardware accelerator 30 is configured to terminate the job in response to receiving the command from the firmware 34 to terminate the job or in response to the timing data 52 of the command 48 (FIG. 4) (e.g., the job duration has passed, or the number of samples have been taken etc.) (block 510). The hardware accelerator 30 is configured to provide an indication to the firmware 34 running on the microcontroller 28 when the hardware accelerator 30 completes the job of gathering the telemetry data (block 512).

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A system, comprising a network device application-specific integrated circuit (ASIC), which includes:
a microcontroller to provide a command to a hardware accelerator to perform a job including gathering telemetry data from at least one hardware unit and write the gathered telemetry data to a memory; and
the hardware accelerator to gather the telemetry data from the at least one hardware unit and write the gathered telemetry data to the memory based on the command.

2. The system according to claim 1, wherein the network device ASIC includes the at least one hardware unit.

3. The system according to claim 2, wherein the at least one hardware unit includes ports, buffers, and packet processing circuitry.

4. The system according to claim 1, wherein the microcontroller is to execute firmware to provide the command to the hardware accelerator to perform the job including gathering the telemetry data from the at least one hardware unit and write the gathered telemetry data to the memory.

5. The system according to claim 1, wherein the hardware accelerator is to gather the telemetry data from the at least one hardware unit and write the gathered data to a host memory of a host device connected to the network device via a data communication bus.

6. The system according to claim 5, wherein the microcontroller is to receive a request from software executed by a central processing unit (CPU) of the host device to gather the telemetry data, and in response to receiving the request provide the command to the hardware accelerator to perform the job.

7. The system according to claim 6, wherein:
the hardware accelerator is to provide an indication to the microcontroller when the hardware accelerator completes the job gathering the telemetry data; and
the microcontroller is to provide a notification to the software executed by the CPU that the job has been completed.

8. The system according to claim 1, further comprising a host device including: a host memory; and a CPU to execute software to provide a request to the microcontroller to gather the telemetry data and write the gathered telemetry data to the host memory, wherein:
the microcontroller is to, in response to receiving the request, provide the command to the hardware accelerator to perform the job; and
the hardware accelerator is to gather the telemetry data from the at least one hardware unit and write the gathered telemetry data to the host memory.

9. The system according to claim 8, wherein:
the hardware accelerator is to provide an indication to the microcontroller when the hardware accelerator completes the job gathering the telemetry data; and
the microcontroller is to provide a notification to the software executed by the CPU that the job has been completed.

10. The system according to claim 1, wherein network device is a network switch, and the hardware units include switching circuitry.

11. The system according to claim 1, wherein the hardware accelerator includes a direct memory access (DMA) hardware accelerator.

12. The system according to claim 1, wherein the hardware accelerator is to sample the telemetry data from the at least one hardware unit at a rate faster than every millisecond.

13. The system according to claim 1, wherein the hardware accelerator is to sample the telemetry data from the at least one hardware unit so that each sample includes a timestamp and values gathered from the at least one hardware unit.

14. The system according to claim 1, wherein the gathered telemetry data includes any one or more of the following: counter values maintained by the at least one hardware unit; values from histograms; and temperature values.

15. The system according to claim 14, wherein the counter values provide an indication of any one or more of the following: a number of packets transmitted and/or received; a number of bytes transmitted and/or received; buffer occupancy for a given one of the ports for a given one of the buffers or a priority on the given port; and a number of pause frames transmitted and/or received; and a number of inbound packets chosen to be discarded.

16. The system according to claim 1, wherein:
the hardware accelerator is to provide an indication to the microcontroller when the hardware accelerator completes the job gathering the telemetry data; and
the microcontroller is to provide a notification to software executed by a CPU of a host device that the job has been completed.

17. The system according to claim 16, wherein the command for the job indicates the at least one hardware unit and timing data including any one or more of the following: a duration of the job; a number of samples to be taken; a sampling frequency; or a time gap between each of the samples.

18. The system according to claim 1, wherein the command for the job indicates the at least one hardware unit and timing data including any one or more of the following: a sampling frequency; or a time gap between each of the samples.

19. The system according to claim 18, wherein the job has a fixed duration defined by the timing data including a duration of the job or a number of samples to be taken.

20. The system according to claim 18, wherein the command for the job indicates that the telemetry data is to be written to a ring buffer in the memory.

21. The system according to claim 18, wherein the microcontroller is to:
receive a request from software executed by a CPU of a host device that the job should be terminated; and
provide a command to the hardware accelerator to terminate the job.

22. The system according to claim 1, wherein the hardware accelerator is to clear the telemetry data from the at least one hardware unit upon gathering the telemetry data.

23. A method, comprising:
providing a command by a microcontroller to a hardware accelerator to perform a job including gathering telemetry data from at least one hardware unit and write the gathered telemetry data to a memory; and
gathering by the hardware accelerator the telemetry data from the at least one hardware unit and write the gathered telemetry data to the memory based on the command.
